(19) United States
(12) Patent Application Publication
(10) Pub. No.: US 2014/0302831 A1
(43) Pub. Date: Oct. 9, 2014

(54) Advanced social networking

(71) Applicants: Mathew Ogram, Tuscon, AZ (US); Crystal Ogram, Los Angeles, CA (US); Mark Ogram, Tucson, AZ (US)

(72) Inventors: Mathew Ogram, Tuscon, AZ (US); Crystal Ogram, Los Angeles, CA (US); Mark Ogram, Tucson, AZ (US)

(21) Appl. No.: 13/986,126

(22) Filed: Apr. 3, 2013

(51) Int. Cl. H04M 3/56

(52) U.S. Cl. CPC H04M 3/56
USPC 455/416

(57) ABSTRACT

A networking system which employs a central computer and at least one cellular telephone. The system allows the central computer to, in response to an inquiry from a remote user, to place the inquiry accessible to other users and to communicate an alert message to another remote user via a cellular telephone associated this user. Due to these contacts, the central computer receives a response from the user of the cellular telephone.

This is a continuation of U.S. patent application Ser. No. 13/068,630, filed on May 17, 2011, and entitled “Advanced Social Networking”.

### BACKGROUND OF THE INVENTION

This invention relates generally to social networking and more particularly to an enhanced communication system.

Key to any social network is the ability to efficiently communicate information. If the inquiry or information fails to be fully disseminated, then the overall efficiency of the network suffers dramatically.

It is clear that improvements in communications are essential to assist in the advancement of social networking.

### SUMMARY OF THE INVENTION

The invention provides a networking system which employs a central computer and at least one cellular telephone. The system allows the central computer to, in response to an inquiry from a remote user, to place the inquiry accessible to other users and to communicate an alert message to another remote user via a cellular telephone associated this user. Due to these contacts, the central computer receives a response from the user of the cellular telephone.

Networking, sometimes referred to as social networking, has grown in popularity and use over recent years and is well known to those of ordinary skill in the art, including, but not limited to: U.S. Pat. No. 7,917,853, entitled “System and Method of Presenting Media Content” issued to Trauth on Mar. 29, 2011; U.S. Pat. No. 7,917,594, entitled “Method and System for Notifying an Invitee User When an Inviting User Accesses a Social Networking Application” issued to Reding et al. on Mar. 29, 2011; U.S. Pat. No. 7,912,852, entitled “Search-Caching and Threshold Altering for Commerce Sites” issued to McElroy on Mar. 22, 2011; U.S. Pat. No. 7,912,803, entitled “Creating a Session Log with a Table of Records for a Computing Device Being Studied for Usability by a Plurality of Usability Experts” issued to Bodin et al. on Mar. 22, 2011; U.S. Pat. No. 7,908,270, entitled “System and Method for Managing Access to Media Assets” issued to Spiegelman on Mar. 15, 2011; U.S. Pat. No. 7,904,461, entitled “Advertiser and User Associations” issued to Baluja et al. on Mar. 8, 2011; U.S. Pat. No. 7,904,414, entitled “Adaptive Multi-Channel Answering Service for Knowledge Management Systems” issued to Isaacs on Mar. 8, 2011; U.S. Pat. No. 7,900,203, entitled “Data Sharing and Synchronization with Relay Endpoint and Sync Data Element” issued to Ozzie et al. on Mar. 1, 2011; and, U.S. Pat. No. 7,890,871, entitled “System and Method for Dynamically Generating, Maintaining, and Growing and Online Social Network” issued to Etkin on Feb. 15, 2011; all of which are incorporated hereinto by reference.

This invention is a networking system which utilizes a central computer which is accessible by multiple remote users via a network such as the Internet. Further, the central computer utilizes the cellular telephone system to communicate with at least one cellular telephone.

The central computer, in the preferred embodiment and in response to an inquiry from a first user via the network, places the inquiry so it is accessible to users via the network. Additionally, the central computer communicates an alert message to a second remote user via a cellular telephone system. The central computer also receives a response from said second remote user either from the cellular telephone system or via the network.

When using the cellular telephone system for communication, the central computer further has the capability to shorten the original inquiry to a shortened inquiry having an overall length less than a defined number of characters (established by the messaging system limitations). This capability to shorten the original inquiry allows for easy communication with the remote user's cellular telephone.

Shortening of the original inquiry, in one embodiment, utilizes the key words from the inquiry. In another embodiment, abbreviations of selected words within the inquiry are used to shorten the original inquiry for efficiency with the cellular telephone.

Still further, the central computer in some embodiments has the capability to expand a response to a lengthened response and then post the lengthened response on the network/Internet. This translation from a shortened version to a lengthened version provides for easier understanding and readability. This lengthening is, in one embodiment, a lengthening of abbreviations into their equivalent full words.

The system of this invention is even further enhanced in an embodiment where the central computer communicates the response to the cellular telephone of the party making the original inquiry, whether the original inquiry is derived from the network/Internet or not. An example of this might be where an inquiry was made relate to food preparation. The response from a qualified chef is then sent to the cellular telephone associated with the inquiry so that the party has the answer without the need of computer access.

The invention, together with various embodiments thereof, will be more fully explained by the accompanying drawings and the following descriptions thereof.

### DRAWINGS IN BRIEF

FIG. 1 is a schematic illustrating the interactions of the various components in the preferred system.

FIG. 2 is a flow-chart of the preferred operation of the central computer.

FIG. 3 is a flow-chart of the preferred operation of the central computer in shortening or expanding an inquiry or message.

### DRAWINGS IN DETAIL

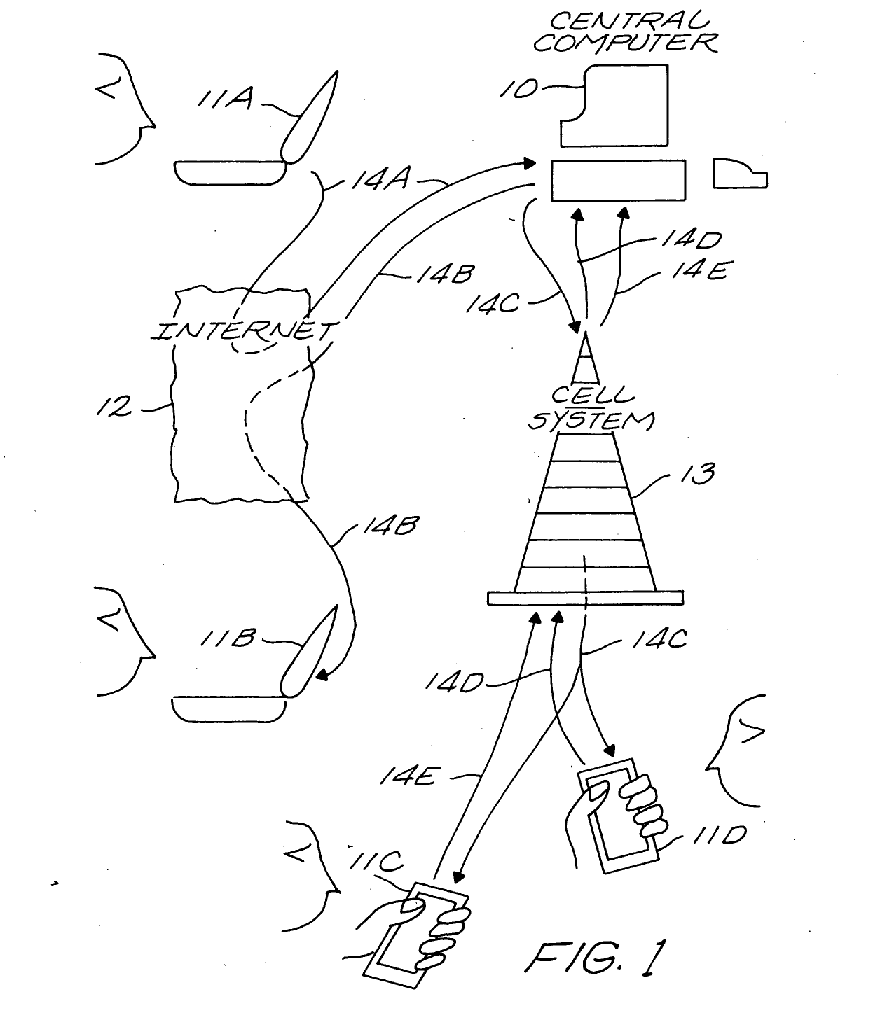

FIG. 1 is a schematic illustrating the interactions of the various components in the preferred system.

For purposes of this discussion, the subject matter for explanatory purpose only, relates to food preparation. Those of ordinary skill in the art readily recognize that the invention is not intended to be so limited and includes any and all subject matters.

The invention is a networking system which utilizes a central computer 10 which is accessible by multiple remote users (11A and 11B) via a network such as the Internet 12, as well as users 11C and 11D accessed via the cellular system 13.

The central computer 10, in the preferred embodiment and in response to an inquiry 14A from a first user 11A via the network 12, places the inquiry so it is accessible to users 11B via the network 12. Using the food example, user 11A may post an inquiry on the central computer 10 such as:
“Help, I have to make breakfast for my fiancee's parents and all I really have are eggs, flour, and some milk. Any ideas?”

This message is posted verbatim on a website allowing user 11B to retrieve the message and allowing user 11B to respond if they so desire.

Additionally, the central computer 10 communicates an alert message 14C to a second remote user 11D via a cellular telephone system 13. User 11D has been identified by the Central Computer 10 as an individual who has particular expertise in the field of the inquiry. This expertise is established through a registry type of file contained within Central Computer 10.

In the example, user 11D has been identified as one who an expert chef in the field of “breakfast” which has been used as a keyword in the inquiry. The inquiry's keywords are used to establish the experts.

Because of the limited message size for the cellular telephone used by user 11D, the initial inquiry is shortened to fit the demands of the cellular telephone. In this example, the shortened message/alert to user 11D might read:
“Breakfast? eggs, flour, milk”Should user 11D wish to respond, 14D, their comments/recommendations are passed along to user 11A who may then follow-up for more information with user 11D. In the context of the food example, user 11D may respond 14D:
“Try Belgium Waffles if you have a little sugar”

The shortened message 14C is also made available to other users 11C via the cellular system 13; thereby permitting users 11C to add their responses to the mix 14E communicated to user 11A.

In this fashion, the central computer 10 receives responses (14B and 14D) via the cellular telephone system 13 or via the network 12.

In similar fashion, the initial inquiry may also be received by the Central Computer 10 via the cellular system 13 and the inquiry is handled in the same fashion of identifying experts and posting the inquiry onto network/Internet 12.

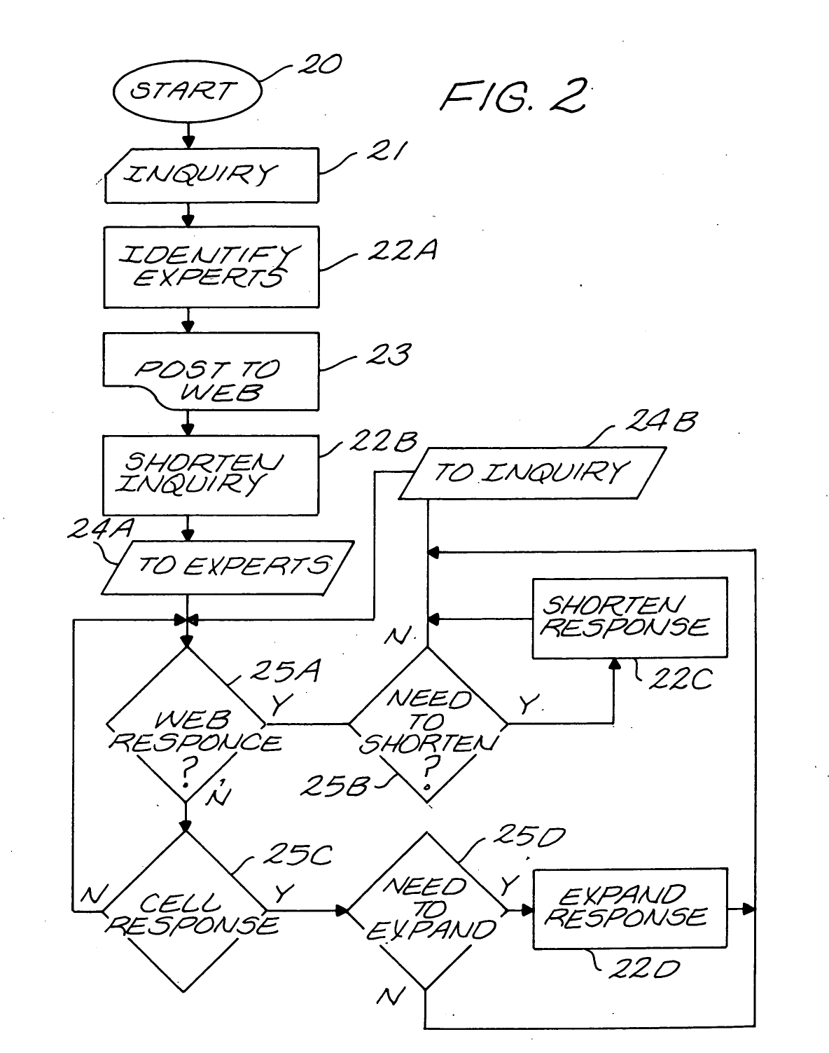

FIG. 2 is a flow-chart of the preferred operation of the central computer.

Once the program starts 20, the inquiry is read 21. By analyzing the inquiry's keywords, the proper experts are identified 22A. These experts have previously registered themselves as having expertise certain areas. Using the example above, the experts may be able to select such expertise as:

| Breakfast | Lunch | Dinner | Snacks |
|---|---|---|---|
| Pizza | Pasta | Desserts | Pastry |
| Egg Dishes | Steaks | Bar-B-Que | Salads |
| Vegetarian | Vegan | Asian Food | Soups |

The inquiry is posted 23 to the web/Internet/Network so that other users of the system may see it and respond.

The initial inquiry is shortened 22B and the shortened version is sent to the experts 24A as identified above.

The program goes into a monitoring phase in which the web is checked for a response 25A. If a web response is detected (Y), then a determination is made if the response must be shortened 25B. If the response must be shortened for the medium of the inquiry (Y) (for a cellular telephone), the response is shortened 22C before the response is sent to the inquiry source 24B. Should the response not need to be shortened 25B (N), then the response, as received, is sent to the Inquiry source 24B and the program continues to monitor for a web response 25A.

Should there not be a web response 25A (N), then the program checks for a response via the cellular telephone system 25C. If no response is detected (N), the program continues back to check for web responses 25A. If there has been a response from the cellular telephone system 25C (Y), a check to see if the message should be expanded is made 25D and the message is expanded 22D if appropriate (Y). The proper message is then sent the inquiry source 24B.

In this manner, the central computer is able to accept an inquiry, send it along through different channels, receive responses, and communicate the responses back to the source of the inquiry.

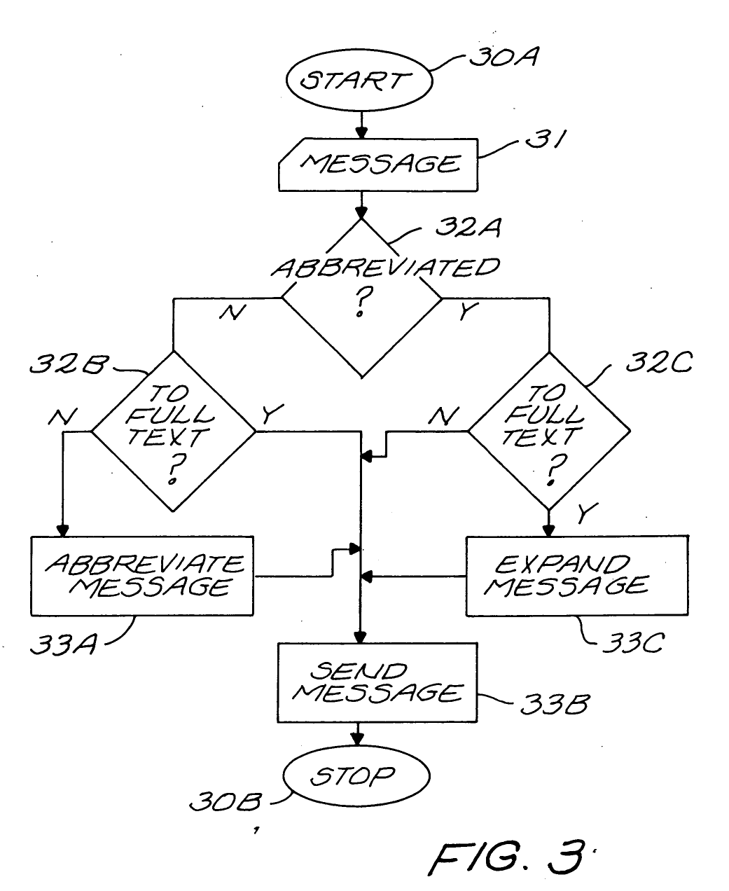

FIG. 3 is a flow-chart of the preferred operation of the central computer in shortening or expanding an inquiry or message.

When using the cellular telephone system for communication, the central computer further has the capability to shorten the original inquiry to a shortened inquiry. This is often required for SMS and other messaging which has strict message length restrictions. This capability to shorten the original inquiry allows for easy communication with the remote user's cellular telephone.

Once the program starts 30A, the incoming message is received 31 and a determination is made if the message is abbreviated 32A. If it is (Y), then a determination is made if the message should be converted to full text 32C and if so (Y), the message is expanded 33C and the expanded message is sent 33B to the proper party via the chosen medium (network or cellular telephone system).

Using the above example, where the expert responded to the inquiry with:
“Try Belgium Waffles if you have a little sugar”

The program may want to expand the short message to:
“A recommendation for Belgium Waffles has been made. You will need some sugar. Please go to the following site BelgiumWafflesRUs.com to get a full recipe and cooking instructions.”

In expanding the original abbreviated message, in some embodiments of the invention, abbreviations are expanded to the literal meaning. As example, the incoming message may be:
“Have EVOO, pasta, and butter?”

In the expanded form:
“I have extra virgin olive oil, some pasta and butter. Any Ideas?

Should the message not be expanded (4) 32C, then the message as received is sent 33B to the appropriate party via the proper channel and the program stops 30B.

If the incoming message is not in abbreviated form 32A (N), then a determination is made on if the message should be converted to full text 32B. If it is to be abbreviated (N), then the message is abbreviated 33A, and sent to the abbreviated message is sent 33B to the proper party; the program then stops 30B.

Using the above example, if the incoming message is:
“I have extra virgin olive oil, some pasta and butter. Any Ideas?

In abbreviated form it might read:
“Have EVOO, pasta, and butter?”

If the message is acceptable as full text 32B (Y), then the message is sent 33B and the program stops 30B.

It is clear that the present invention provides a greatly enhanced communication capability for social networking.

What is claimed is:

1. A networking system comprising:
a) a central computer being accessible by multiple remote users via the Internet, said central computer containing a memory of experts;
b) a remote user establishing keyword indicia and contact information on the memory of experts via said central computer; and,
c) at least one cellular telephone; and,
wherein said central computer has the capability to,
1) receive an inquiry from a first remote user via said Internet and automatically communicate via a cellular telephone an alert message to selected experts within said memory of experts based upon keywords found in said inquiry, said alert message containing at least a portion of said inquiry to a second remote user, and,
2) receive a first response from at least one of said selected experts.

2. The networking system according to claim 1, wherein said central computer further has the capability to post the alert message on the Internet for access by unidentified individuals.

3. The networking system according to claim 1, wherein said first response is received via the Internet.

4. The networking system according to claim 1, wherein said first response is received via a cellular system communicating with said at least one cellular telephone.

5. The networking system according to claim 4, wherein said central computer further has the capability to,
a) shorten said inquiry from the first remote user to a shortened inquiry having an overall length less than a defined number of characters; and,
b) communicate the shortened inquiry to a third remote user's cellular telephone.

6. The networking system according to claim 5, wherein said shortened inquiry includes key words from said inquiry.

7. The networking system according to claim 5, wherein said shortened inquiry includes abbreviations of selected words within said inquiry.

8. The networking system according to claim 4, wherein said central computer further has the capability to,
a) receive a second response from the third remote user's cellular telephone; and,
b) communicate the second response to the first user via the Internet.

9. The networking system according to claim 4, wherein said inquiry relates to food preparation.

10. The networking system according to claim 9, wherein said inquiry on food preparation contains a list of available ingredients.

11. A network system having a central computer being accessible by multiple remote users via the Internet and at least one cellular telephone, said central computer having the capability to,
a) in response to an inquiry from a first remote user via said Internet, said inquiry containing a list of ingredients, place said inquiry accessible to users via the Internet,
b) automatically communicate an alert message containing a portion of the inquiry to a second remote user via a cellular telephone associated with said second remote user, and,
c) receive a first response from said second remote user.

12. The network system according to claim 11, wherein said central computer further has the capability to,
a) shorten said inquiry from the first remote user to a shortened inquiry having an overall length less than a defined number of characters; and,
b) communicate the shortened inquiry to a third remote user's cellular telephone.

13. The network system according to claim 12, wherein said shortened inquiry includes key words from said inquiry.

14. The network system according to claim 12, wherein said shortened inquiry includes abbreviations of selected words within said inquiry.

15. The network system according to claim 12, wherein said central computer further has the capability to,
a) receive a shortened response from the third user's cellular telephone;
b) expand said shortened response to a lengthened response; and,
c) post the lengthened response on the Internet being accessible to users thereof.

16. The network system according to claim 15, wherein said lengthened response includes full words derived from abbreviations in said shortened response.

17. The network system according to claim 15, wherein said central computer further has the capability to,
a) receive a second response from the third remote user's cellular telephone; and,
b) communicate the second response to the first user via the Internet.

18. A communication system having a central computer being accessible by multiple remote computers via the Internet and multiple cellular telephones, wherein said central computer has the capability to,
1) in response to an inquiry containing a list of ingredients from a first remote user via said Internet,
a) place said inquiry accessible to users via the Internet, and
b) communicate an alert message containing at least a portion of the inquiry to a second remote user via a cellular telephone associated with said second remote user, and,
2) receive a first response from said second remote user.

19. The communication system according to claim 18, wherein said first response is accessible to users via the Internet and is associated with said inquiry.
